(19) United States
(12) Patent Application Publication
(10) Pub. No.: US 2013/0276491 A1
(43) Pub. Date: Oct. 24, 2013

(54) BASE ASSEMBLY FOR A LOCK

(71) Applicant: TAIWAN FU HSING INDUSTRIAL CO., LTD., Kaohsiung City (TW)

(72) Inventors: Lien-Hsi Huang, Kaohsiung City (TW); Jian-Yuan Huang, Kaohsiung City (TW)

(73) Assignee: TAIWAN FU HSING INDUSTRIAL CO., LTD., Kaohsiung City (TW)

(21) Appl. No.: 13/684,684

(22) Filed: Nov. 26, 2012

(30) Foreign Application Priority Data
Apr. 23, 2012 (TW) 101114442

(51) Int. Cl. E05B 9/00

(52) U.S. Cl. CPC E05B 9/002
USPC 70/448

(57) ABSTRACT

A base assembly for a lock installed at a lock module includes a base, a connection member, at least one fixing member and an escutcheon coupled to the connection member. The base is coupled to the lock module, and the connection member is coupled to the base via the at least one fixing member. The connection member is located between the base and the escutcheon, and a portion of the connection member covers the base. The base may couple with different shapes of escutcheons via the connection member.

### FIELD OF THE INVENTION

The present invention is generally related to a base assembly for a lock, which particularly relates to the base assembly installed at a lock module, and the base assembly couples with different shapes of escutcheons on demand.

### BACKGROUND OF THE INVENTION

Please refer to FIG. 10, a conventional base assembly 10 includes a base 11 and an escutcheon 12, wherein the base 11 is coupled to a lock module (not shown in Figs.) and comprises a positioning slot 11a, and the escutcheon 12 comprises a positioning portion 12a. When the lock module is installed at a door plank, the base 11 is covered with the escutcheon 12, and the positioning portion 12a of the escutcheon 12 is jammed into the positioning slot 11a of the base 11. However, each user has various demands on the shape of the escutcheon 12. If a user selects a rectangular-shaped escutcheon, mentioned rectangular-shaped escutcheon can not be installed at a round-shaped base.

### SUMMARY

An escutcheon can not be installed at a base for the reason that the shape of the escutcheon is different from that of the base. In this invention, a connection member is disposed between the base and the escutcheon to make different shapes of escutcheons capable of being installed at the base.

The primary object of the present invention is to provide a base assembly for a lock including a base, a connection member, at least one fixing member and an escutcheon coupled to the connection member. The connection member is located between the base and the escutcheon, wherein a portion of the connection member covers the base, and the connection member is coupled to the base via the fixing member. The base may couple with different shapes of escutcheons via the connection member to meet user demand.

### DESCRIPTION OF THE DRAWINGS

FIG. 1 is a perspective exploded view illustrating a base assembly for a lock in accordance with a first embodiment of the present invention.

FIG. 2 is a partial exploded view illustrating a base assembly for a lock in accordance with a first embodiment of the present invention.

FIG. 3 is a perspective assembly view illustrating a base assembly for a lock in accordance with a first embodiment of the present invention.

FIG. 4 is a section view illustrating a base assembly for a lock with a first embodiment of the present invention.

FIG. 5 is a section view illustrating a base assembly for a lock in accordance with a second embodiment of the present invention.

FIG. 6 is a section view illustrating a base assembly for a lock in accordance with a third embodiment of the present invention.

FIG. 7 is a perspective exploded view illustrating a base assembly for a lock in accordance with the present invention.

FIG. 8 is a perspective exploded view illustrating a base assembly for a lock in accordance with the present invention.

FIG. 9 is a perspective exploded view illustrating a base assembly for a lock in accordance with the present invention.

FIG. 10 is a perspective exploded view illustrating a conventional base assembly.

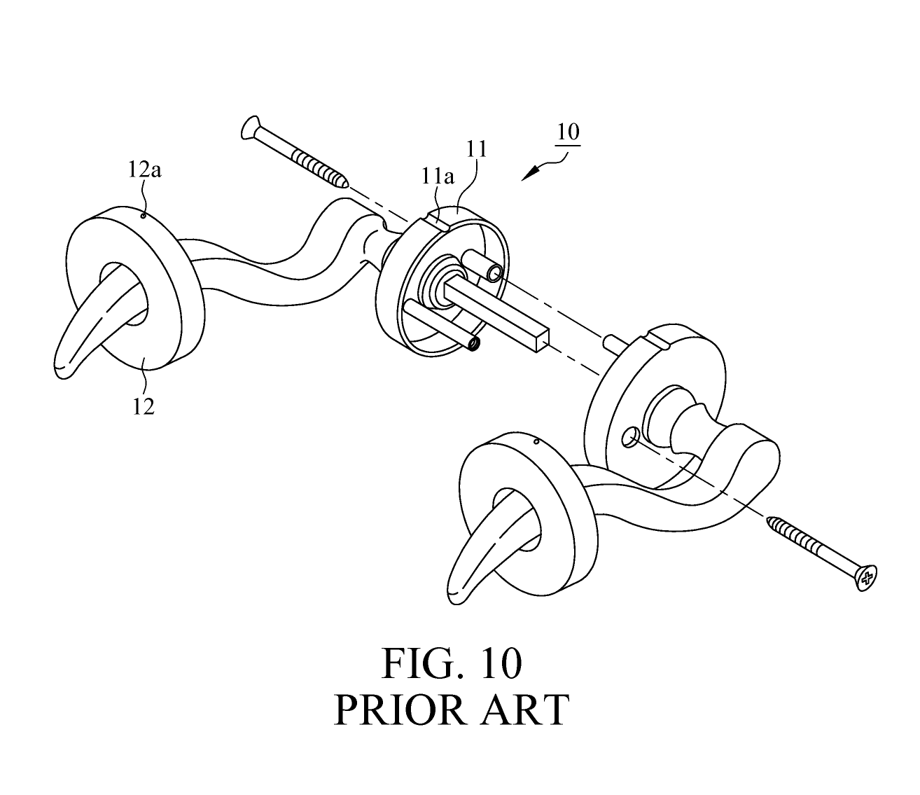

### DETAILED DESCRIPTION OF THE INVENTION

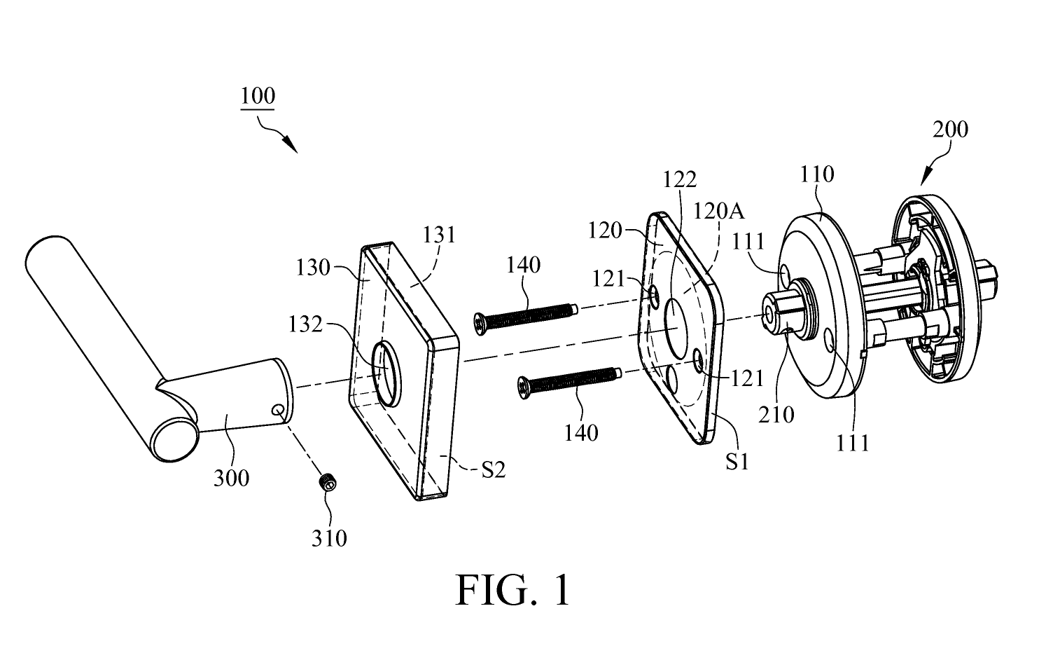

With reference to FIGS. 1 to 4, a base assembly for a lock 100 installed between a lock module 200 and a handle 300 in accordance with a first embodiment of the present invention includes a base 110, a connection member 120, an escutcheon 130 and at least one fixing member 140, wherein the base 110 is round shaped, the connection member 120 is plate-shaped, the escutcheon 130 is non-round shaped, and the handle 300 is driven to rotate along its axis by an exerted force, usually, the handle 300 is a lever or a knob.

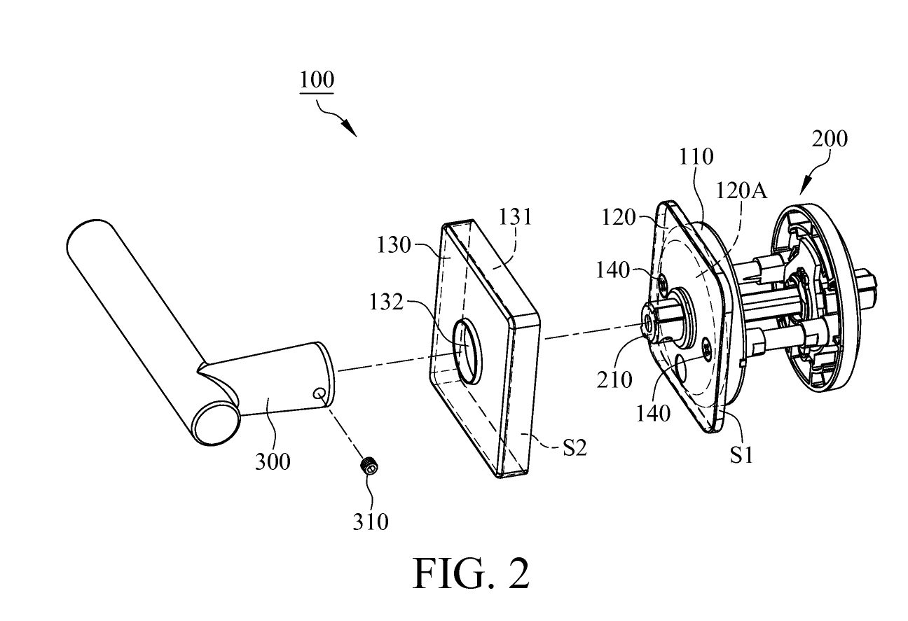

Referring to FIGS. 1 and 2, the base 110 is coupled to the lock module 200, the base 110 comprises at least one first penetration hole 111, and the connection member 120 comprises at least one second penetration hole 121 corresponded to the first penetration hole 111. In this embodiment, the fixing member 140 is a screw rod. The fixing member 140 is penetrated through the first penetration hole 111 and the second penetration hole 121 to enable the connection member 120 to couple to the base 110. In this embodiment, the connection member 120 is coupled to the base 110 via the at least one fixing member 140. Preferably, the connection member 120 is coupled to the base 110 via a helical force applied on the fixing member 140, usually there are two fixing members 140 used in this embodiment, each fixing member 140 is a threaded screw, and each fixing member 140 penetrates through the connection member 120 and engages with the base 110.

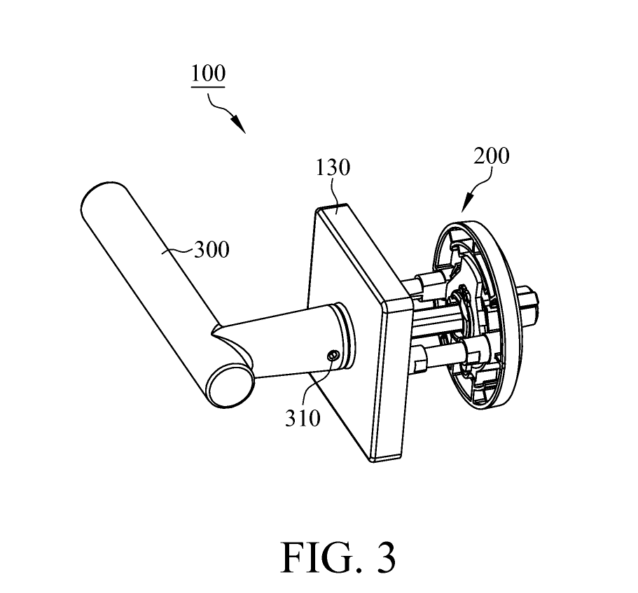

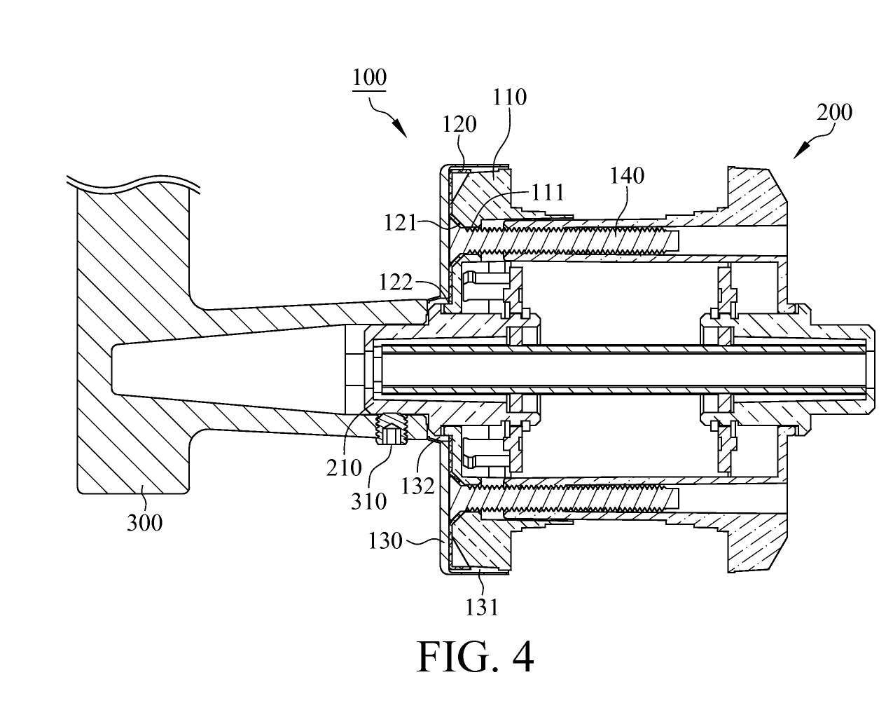

With reference to FIGS. 1, 2, 3 and 4, the connection member 120 is located between the base 110 and the escutcheon 130, wherein the escutcheon 130 is coupled to the connection member 120, a portion 120A of the connection member 120 covers the base 110, and at least part of the escutcheon 130 covers the connection member 120. The connection member 120 has a first profile S1, and the escutcheon 130 has an inner profile S2 engaged with the first profile S1 of the connection member 120. Referring to FIGS. 3 and 4 again, the escutcheon 130 comprises an accommodating slot 131, and the connection member 120 is accommodated within the accommodating slot 131. Preferably, the connection member 120 can be lodged into the accommodating slot 131.

With reference to FIGS. 2 and 4, the escutcheon 130 is located between the connection member 120 and the handle 300. The base assembly for a lock 100 comprises an axial line penetrated through a latch assembly (not shown in Figs.) vertically, wherein the handle 300 circles the axial line for rotation and actuates a door lock into an unlock state or a lock state. Besides, when the connection member 120 is coupled to the base 110, solid structure of combining portion between the connection member 120 and the base 110 extends along the direction of the axial line. For instance, the fixing member 140 is a combining solid structure between the connection member 120 and the base 110, and the fixing member 140 is a screw rod extended along with the direction of the axial line.

The escutcheon 130 comprises an insertion hole 132, the lock module 200 comprises a transmission member 210 rotatably coupled to the base 110 and is driven by the handle 300, wherein the transmission member 210 passes the base 110, the connection member 120 and the escutcheon 130 to engage with the handle 300. Preferably, the transmission member 210 penetrates through the insertion hole 132 as well. In this embodiment, the connection member 120 further comprises a through hole 122, the transmission member 210 passes through the through hole 122 of the connection member 120 and the insertion hole 132 of the escutcheon 130, and the transmission member 210 protrudes to the escutcheon 130 and couples to the handle 300. In this embodiment, the handle 300 is fixedly coupled to the transmission member 210 via a fixing element 310. Referring to FIG. 4 the escutcheon 130 and the connection member 120 are clipped between the handle 300 and the base 110 for increasing the coupling strength of the escutcheon 130, the connection member 120 and the lock module 200.

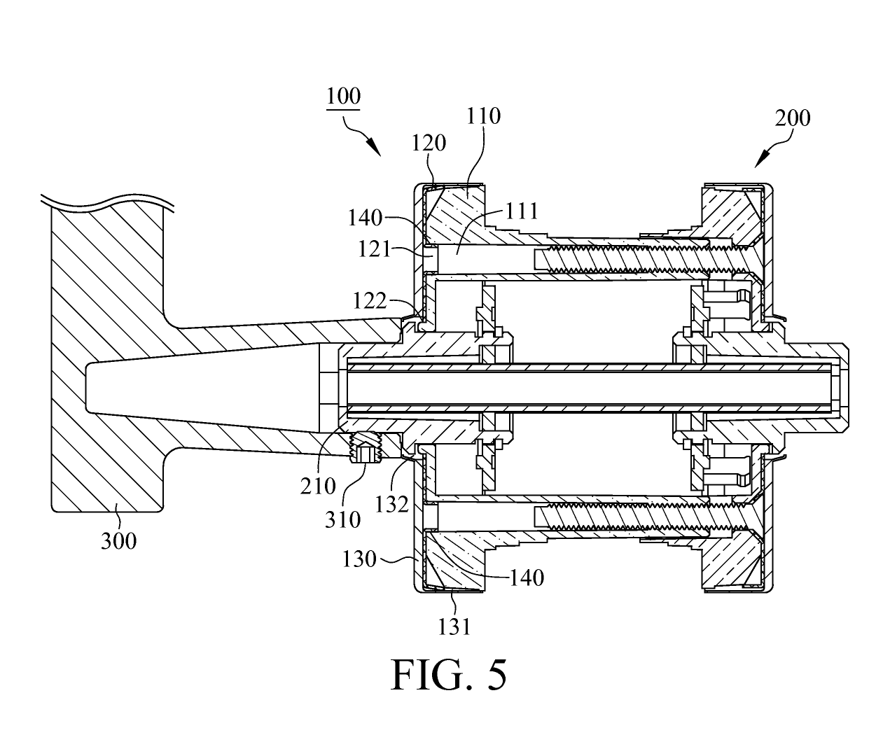

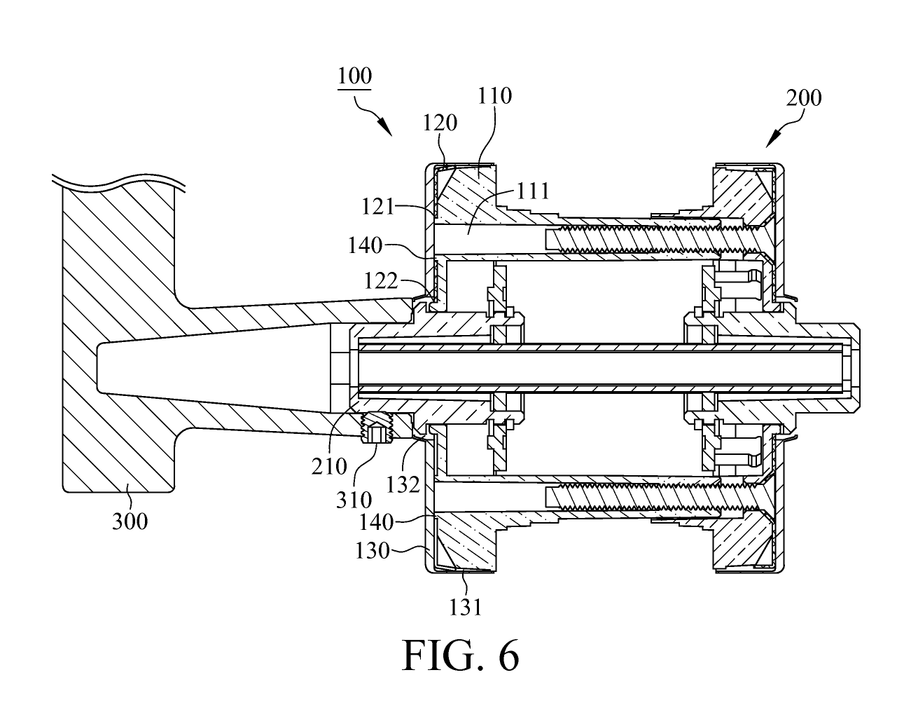

A second embodiment of the present invention is illustrated in FIG. 5. A base assembly for a lock 100 includes a base 110, a connection member 120, an escutcheon 130 and at least one fixing member 140. The difference between the second embodiment and the first embodiment is that the fixing member 140 protrudes to the connection member 120 and extends toward the base 110, and the fixing member 140 is coupled to the first penetration hole 111 of the base 110. Or, a third embodiment of the present invention is disclosed in FIG. 6, the fixing member 140 protrudes from the base 110 and extends toward the connection member 120, and the fixing member 140 is coupled to the second penetration hole 121 of the connection member 120. This structure also meets the description of solid structure of combining portion extended along the direction of the axial line. For instance, the fixing member 140 is a projecting ring extended along the direction of the axial line. Furthermore, the fixing member 140 is coupled to the first penetration hole 111 of the base 110 in FIG. 5. Or, the fixing member 140 is coupled to the second penetration hole 121 of the connection member 120 in FIG. 6.

From comparison between FIG. 4 and FIG. 5, the base assembly for a lock 100 enables to adopt a screw rod design for the fixing member 140 at one side (outside) of a door as indicated in FIG. 4, and enables to adopt a projecting ring design for the fixing member 140 at another side (inside) of a door as indicated in FIG. 5. Through mentioned designs, the base 110 and the connection member 120 are coupled from each other so that the escutcheon 130 can be coupled to the connection member 120, and at least part of the escutcheon 130 covers the connection member 120.

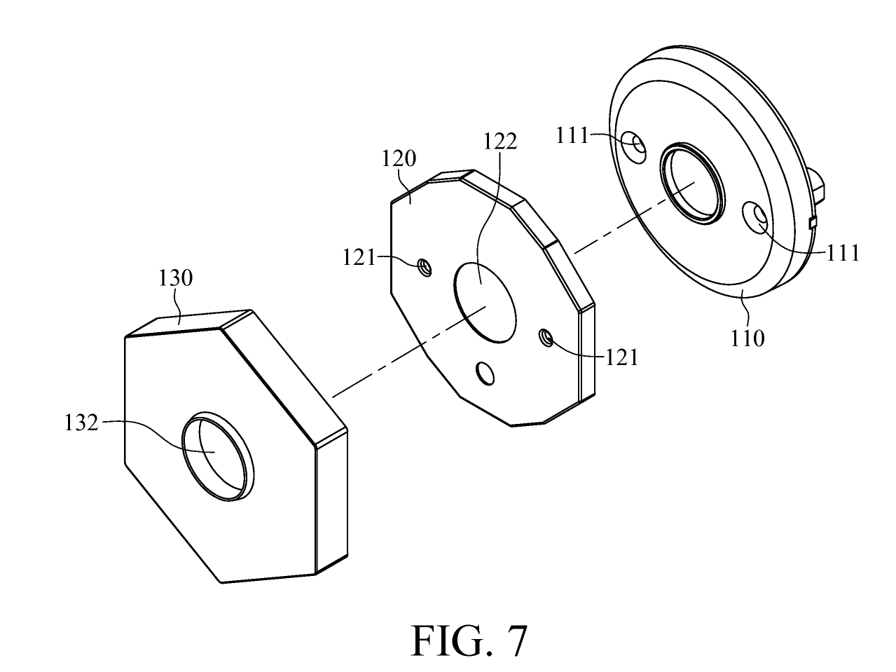

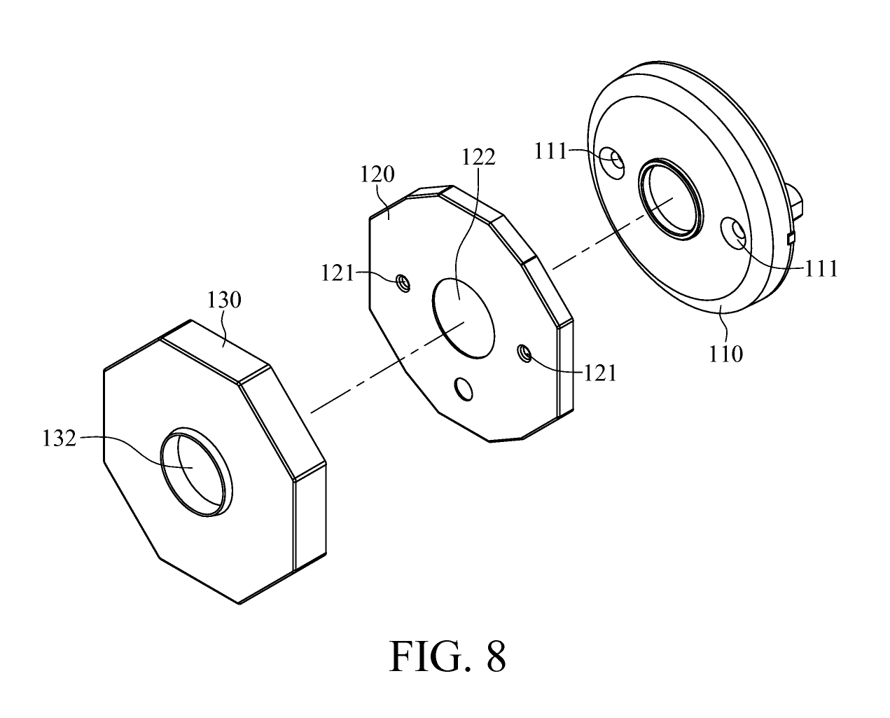

With reference to FIGS. 7-9, the base assembly for a lock 100 may utilize the connection member 120 to couple with different shapes (round shape, rectangular shape, octagon shape, etc.) of the escutcheon 130 on user demand. Besides, the shape of the connection member 120 can be replaced based on certain shape of the escutcheon 130 to meet user demand.

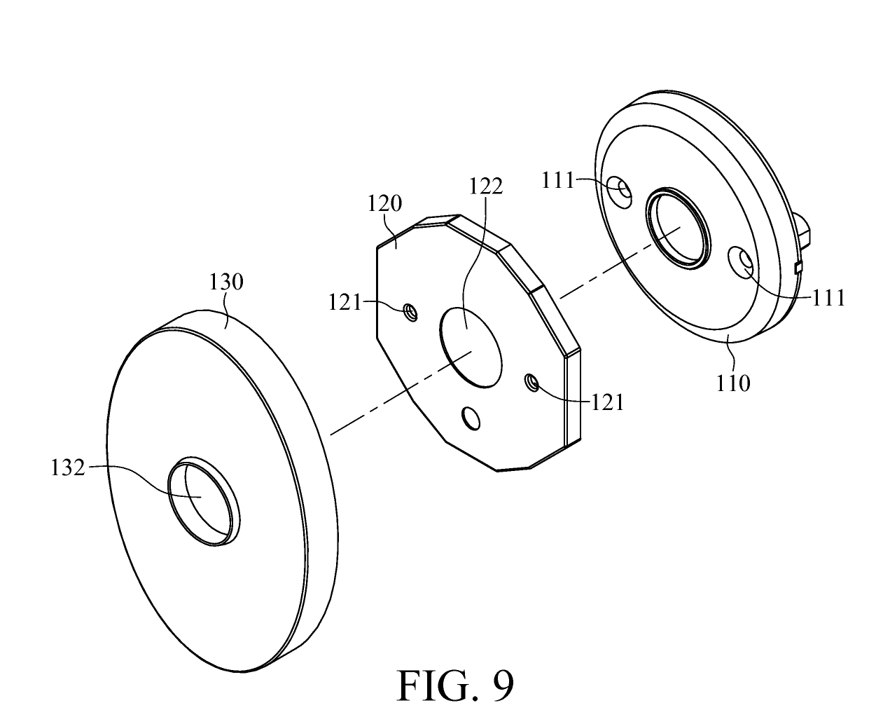

As indicated in FIG. 9, shape consistency for the connection member 120 and the escutcheon 130 is not necessary. If only an edge or a corner of the connection member 120 can be lodged into an inner edge of the escutcheon 130. Therefore, selectivity of the escutcheon 130 is quite diversified.

Otherwise, with reference to FIG. 1, for the reason at least part of the escutcheon 130 covering the connection member 120, the fixing member 140 can be fully covered for making the outline of the base assembly for a lock 100 more pleasing.

While this invention has been particularly illustrated and described in detail with respect to the preferred embodiments thereof, it will be clearly understood by those skilled in the art that it is not limited to the specific features and describes and various modifications and changes in form and detail may be made without departing from the spirit and scope of this invention.

What is claimed is:

1. A base assembly for a lock installed between a lock module and a handle including:
a base coupled to the lock module, wherein the lock module comprises a transmission member rotatably coupled to the base and is driven by the handle;
a connection member, wherein a portion of the connection member covers the base;
at least one fixing member, wherein the connection member is coupled to the base via the at least one fixing member; and
an escutcheon coupled to the connection member, wherein the connection member is located between the base and the escutcheon, the transmission member passes the base, the connection member and the escutcheon to engage with the handle.

2. The base assembly for a lock in accordance with claim 1, wherein the connection member is plate-shaped and has a first profile, and the escutcheon has an inner profile engaged with the first profile of the connection member.

3. The base assembly for a lock in accordance with claim 1, wherein the connection member is coupled to the base via a helical force applied on the fixing member, and the fixing member penetrates through the connection member and engages with the base.

4. The base assembly for a lock in accordance with claim 3, wherein the base comprises at least one first penetration hole, the connection member comprises at least one second penetration hole, the fixing member is penetrated through the first penetration hole and the second penetration hole.

5. The base assembly for a lock in accordance with claim 3, wherein the base comprises at least one first penetration hole, the fixing member protrudes to the connection member and extends toward the base, and the fixing member is coupled to the first penetration hole.

6. The base assembly for a lock in accordance with claim 3, wherein the connection member comprises at least one second penetration hole, the fixing member protrudes to the base and extends toward the connection member, and the fixing member is coupled to the second penetration hole.

7. The base assembly for a lock in accordance with claim 1, wherein the escutcheon comprises an accommodating slot, the connection member is accommodated within the accommodating slot.

8. The base assembly for a lock in accordance with claim 3, wherein the escutcheon comprises an accommodating slot, the connection member is accommodated within the accommodating slot.

9. The base assembly for a lock in accordance with claim 1, wherein the escutcheon is located between the connection member and the handle, the escutcheon comprises an insertion hole, and the transmission member penetrates through the insertion hole.
